(19) United States
(12) Patent Application Publication
(10) Pub. No.: US 2005/0204559 A1
(43) Pub. Date: Sep. 22, 2005

(54) Expanded clamping band for washer

(75) Inventors: James J. Hartwig, Monroe, IA (US); Edwin F. Wegner, Newton, IA (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/803,707

(22) Filed: Mar. 18, 2004

(51) Int. Cl. B23P 15/16

(52) U.S. Cl. 29/896.6; 68/3 R; 68/23.3; 68/23 R; 68/133

(57) ABSTRACT

The present invention includes an expanded metal clamping band for reinforcing a spin tub body of a washer. A metal locking band is assembled to an outer surface of a metal spin tub body to reinforce the spin tub. The spin tub is formed through expanding the metal spin tub body and a metal clamping band together.

### BACKGROUND OF THE INVENTION

The present invention relates to an expanded clamping band for use in a washer and a method for manufacturing a washer having an expanded clamping band.

A typical prior art washer for washing laundry includes a cabinet with an outer tub placed in the cabinet and an inner tub placed within the outer tub. This inner tub is known by various names, including as a “spin tub” or “spinner.” The spin tub contains the clothes or other laundry articles and is rotated at various points in the laundry cycles, particularly during a spin cycle used to extract water from the laundry.

It has been observed that an unbalanced load within the tub results in a lumped mass of clothes in the spin tub. This unbalanced load can exert a force on a localized region of the spin tub. The resulting force has a direct relationship to both the mass of the laundry articles and the radius of the spin tub. This force increases as the square of the angular velocity of the spin tub. Thus, the greater the velocity of the spin tub, the greater the force on localized regions of the spin tub. Also, the greater the size of the spin tub as measured by its radius, the greater the force on the localized regions of the spin tub.

The appliance industry has continued to increase the speed of the spin tubs in order to reduce overall energy consumption through improved extraction of water. This increase in speed also increases the force on localized regions of the spin tub as previously explained.

Therefore, one of the challenges in boosting the spin speed is to prevent deformation of the spin tub. This deformation can reduce the clearance between the spin tub and outer tub to the point where contact occurs. This results in numerous problems including undesirable noise that may result in a service call. Also, this type of deformation can more seriously damage the outer tub, and needs to be avoided.

The spin tub could be made more durable through enlarging the size of the spin tub. However, manufacturers attempt to provide the largest possible spin tub volume given certain constraints. One such constraint is that one industry standard for the width of a washer and dryer pair is 54 inches. Typically, each washer and dryer is 27 inches wide to allow usage of common cabinetry components on the washer and dryer. The design of the suspension system in a washer further necessitates some amount of clearance between the outer tub and cabinet to accommodate movement of the dynamic system during spin without creating cabinet hits. Further, some amount of clearance is necessary between the spin tub and the outer tub. Each of these constraints further limits the available spin tub volume.

Therefore, what is needed is a washer having a spin tub or spinner that improves upon the state of the art.

A further object, feature, or advantage of the present invention is to provide a washer with a spin tub designed to minimize deformation of the spin tub.

It is a still further object, feature, or advantage of the present invention to reinforce a spin tub without reducing spin tub volume.

Another object, feature, or advantage of the present invention is to provide a spin tub that is suitable for rotating at high speeds while still minimizing deformation due to unbalanced laundry loads.

Yet another object, feature, or advantage of the present invention is to provide a washer that can be made to an industry standard size.

A still further object, feature or advantage of the present invention is to provide a washer having a reinforced spin tub that is easy and cost effective to manufacture. Another object, feature, or advantage of the present invention is to provide a washer that reduces overall energy consumption—a significant buying criteria.

These and/or other objects, features, or advantages of the present invention will become apparent from the specification and claims that follow.

### SUMMARY OF THE INVENTION

The present invention relates to an expanded metal clamping band that forms a portion of a spin tub of a washer. The expanded metal clamping band is used to reinforce the spin tub to minimize deformation when rotated at higher speeds. This higher speed rotation provides a reduction in overall energy consumption. According to one aspect of the present invention a washer includes a cabinet, an outer tub disposed within the cabinet, and a spin tub rotatably mounted within the outer tub. The spin tub includes a metal spin tub upper body and an expanded metal clamping band on an outer surface of the metal spin tub upper body. The expanded metal clamping band reinforces the spin tub in order to help minimize deformation caused by unbalanced loads that are rotated at high speeds, particularly during the water extraction process. The spin tub is formed through expanding the metal spin tub upper body and the metal clamping band together.

According to another aspect of the invention, a spin tub for use in a washer has a cylindrical metal spin tub upper body and an expanded metal clamping band on an outer surface of the spin tub upper body to reinforce the spin tub. The spin tub is formed through expanding the metal spin tub upper body and the metal clamping band together.

Another aspect of the present invention is a method of manufacturing a washer having a spin tub. The method provides for welding a metal band and a metal spin tub upper body. The metal band and metal spin tub upper body are then expanded together.

### BRIEF DESCRIPTION OF THE DRAWINGS

FIG. 1 is a perspective view of one embodiment of a spin tub disposed within a washer according to the present invention.

FIG. 2 is a sectional top view of one embodiment of the washer of the present invention showing a spin tub mounting within a washer.

FIG. 3 illustrates a front cross-sectional view of one embodiment of the upper spin tub body of the present invention.

FIG. 4 illustrates a cross-sectional view of one embodiment of the expanded metal clamp of the present invention attached to an upper spin tub body.

FIG. 5 illustrates one embodiment of the spin tub of the present invention.

FIG. 6 illustrates a top view of one embodiment of a metal clamp of the present invention prior to assembly.

FIG. 7 is a perspective view of one embodiment of a metal clamp and upper spin tub body prior to forming operations.

### DETAILED DESCRIPTION OF THE PREFERRED EMBODIMENT

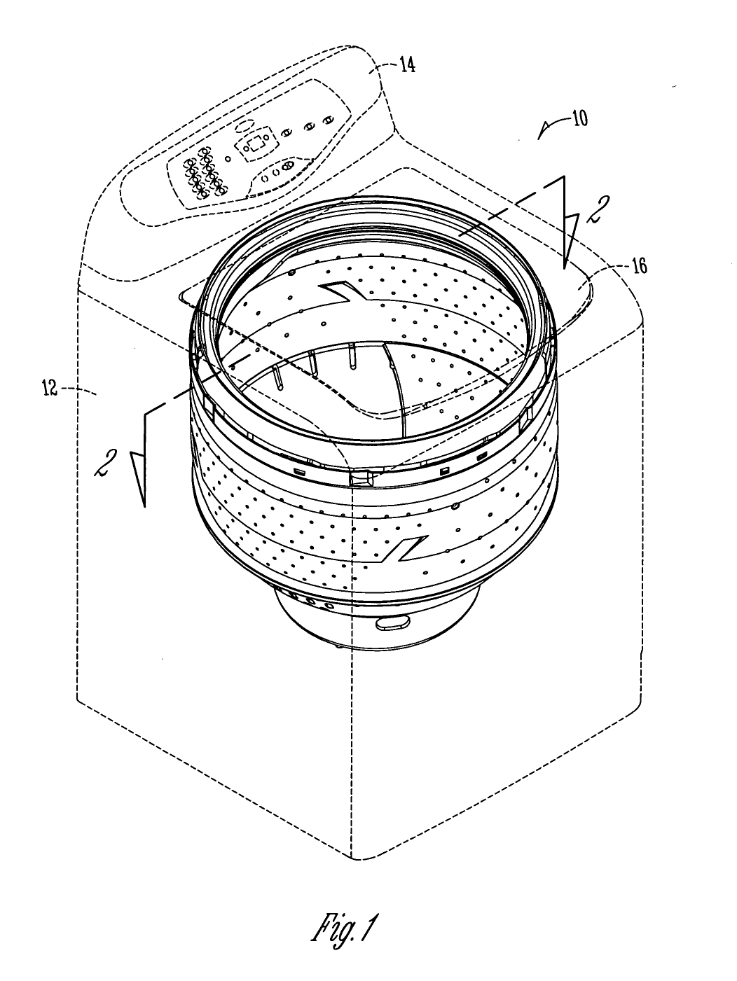

The present invention provides for a washer that uses an expanded clamping band on the spinner or spin tub in order to reinforce the spin tub. FIG. 1 illustrates a perspective view of one embodiment of a washer according to the present invention. The washer 10 illustrated includes a cabinet 12. A control panel 14 is also shown as well as a lid 16. Thus, the washer 10 shown in FIG. 1 is a top-loading washer. The present invention, however, is not limited to a specific configuration of the washing machine shown as various sizes and orientations are known.

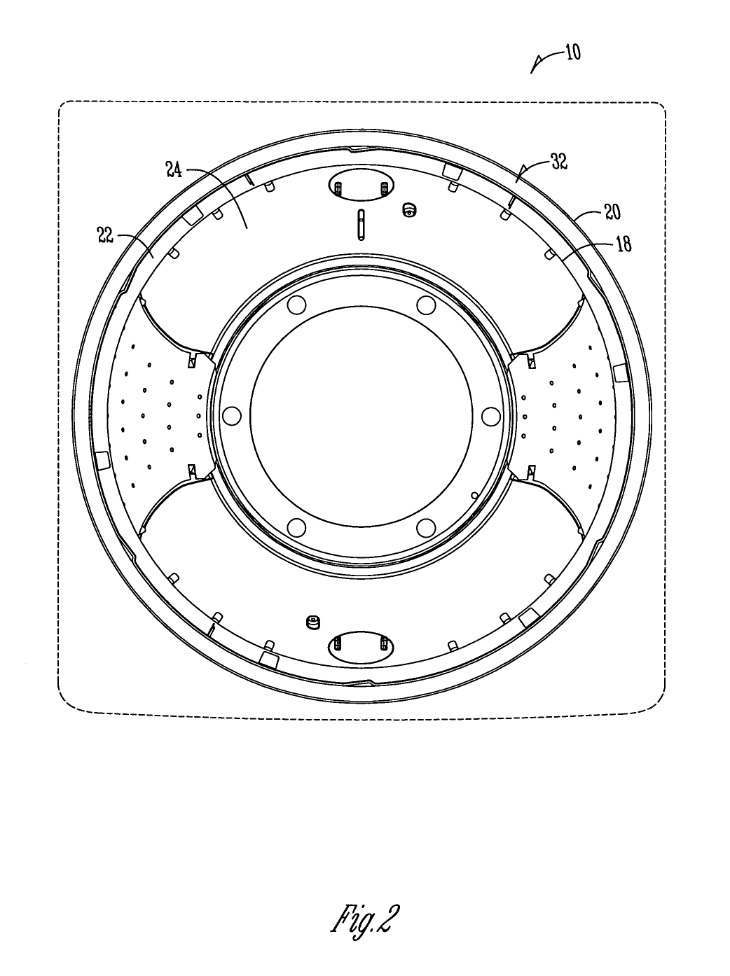

FIG. 2 illustrates a top view of the washer 10 taken along the axis 2-2 of FIG. 1. The washer 10 includes an outer tub 20. Rotatably mounted within the outer tub 20 is spin tub assembly 32, commonly referred to as a spin tub or spinner. The spin tub assembly 32 has an open end 18 shown. This allows laundry articles to be placed within the area 24 enclosed by the spin tub assembly 32.

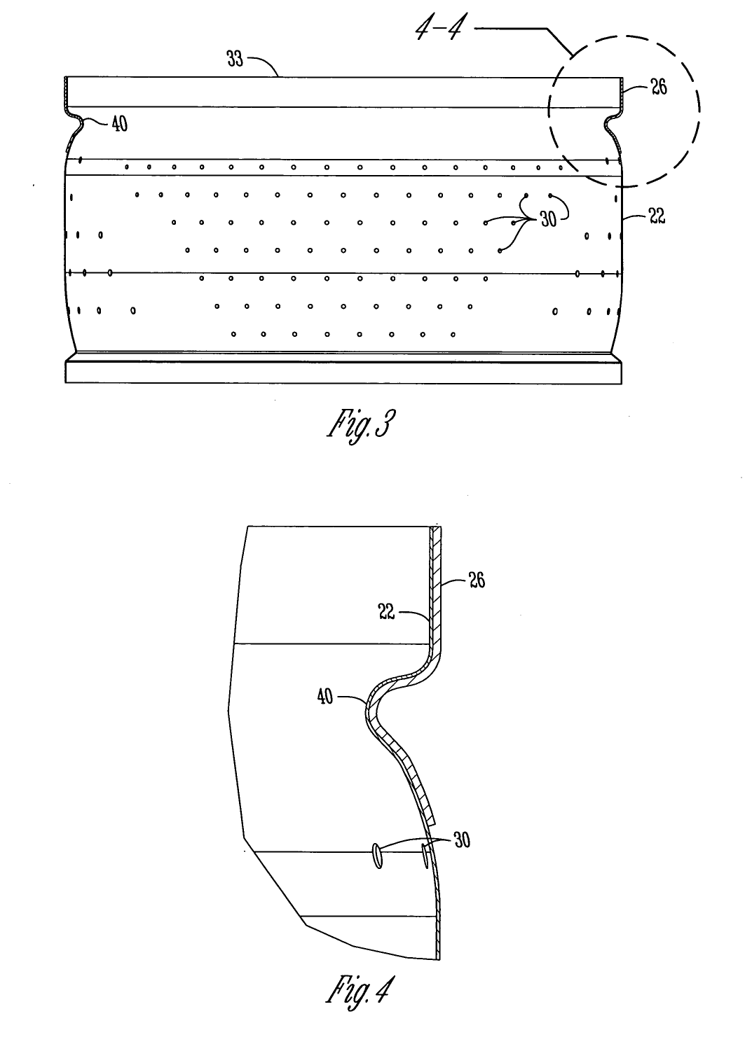

FIG. 3 illustrates a portion of a spin tub. The spin tub includes an upper spin tub body 22. The spin tub body 22 is made of metal, preferably a stainless steel. Positioned along the top of the spin tub body 22 is a metal clamping band 26. As shown in FIG. 3, the metal clamping band 26 is substantially flush with the top edge of the upper spin tub body 22. The clamping band 26 and the upper spin tub body 22 are both of a substantially cylindrical shape. The clamping band 26 and the spin tub body 22 are both in the substantially cylindrical shapes before the forming operations. Then, the metal expansion process is performed on the metal spin tub body and the metal clamping band together. The result is that the spin tub 22 is reinforced with the expanded metal clamping band 26. This helps minimize deformation, especially when the spin tub is operated at high speeds. These high speeds help reduce overall energy consumption by extracting more moisture prior to the drying process.

FIG. 4 illustrates an enlarged view of a cross section taken along lines 4-4 of FIG. 3. FIG. 4 illustrates the metal clamping band 26 and the spin tub body 22 after forming operations are performed. Note that there are a plurality of holes 30 in the spin tub body 22. The clamping band 26 conforms to the shape of the spin tub body 22.

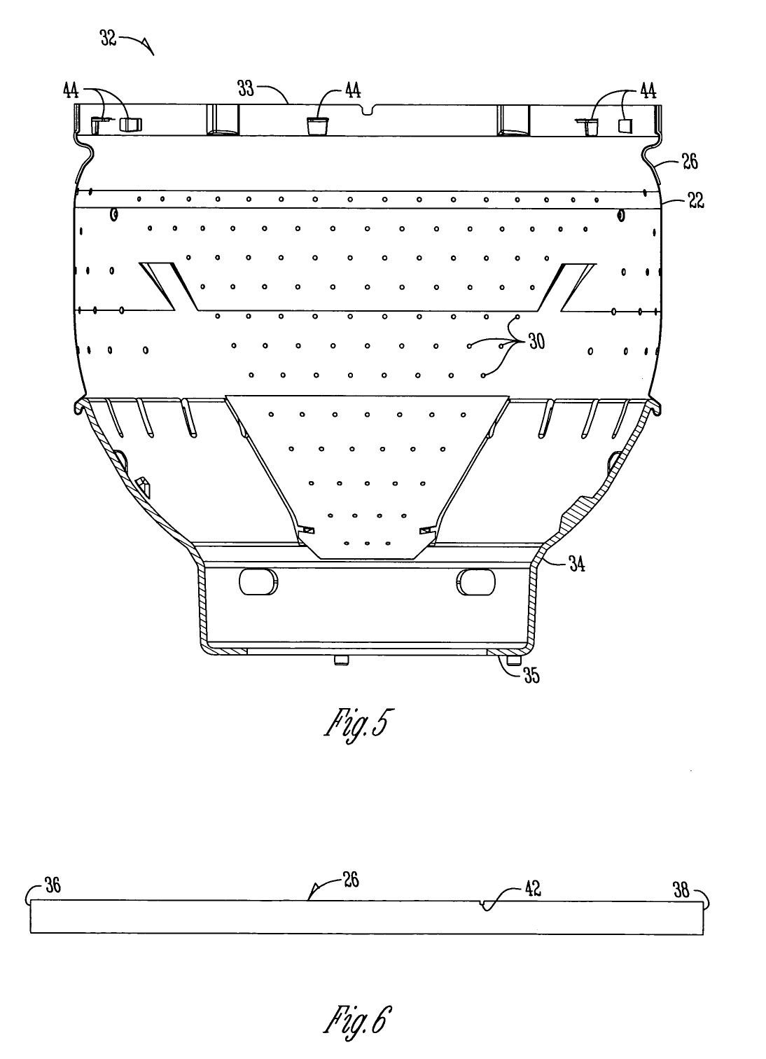

FIG. 5 illustrates a complete spin tub assembly 32 with both the upper spin tub body 22 and a lower spin tub body 34. The upper spin tub body 22 is operatively connected to the lower spin tub body 34. The spin tub assembly 32 includes an open top end 33 and an opposite bottom end 35.

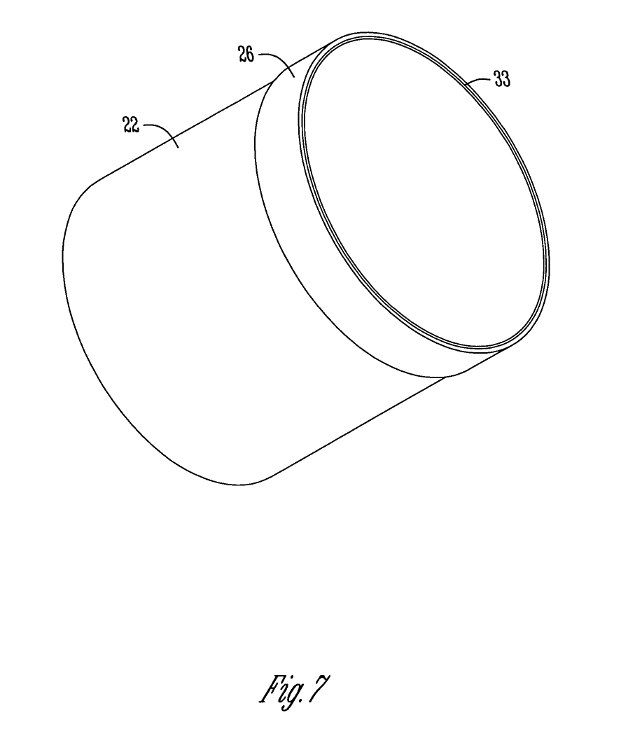

FIG. 6 illustrates a flat metal clamping band 26 prior to assembly. The flat metal clamping band 26 has a notch 42 for assembly orientation. The flat clamping band 26 is formed into a cylinder and the ends 36, 38 are then welded to each other. Similarly, a flat blank of upper spin tub body 22 is formed into a cylinder and welded. After the clamping band 26 has been placed on the outside of spin tub body 22, an expansion process is performed. During expansion, the cylindrical diameters of the spin tub body 22 and clamping band 26 are simultaneously increased in a single operation. After the expansion process, the spin tub body and metal clamping band are roll-formed to create rib 40. A spin tub is then assembled as a part of the manufacturing process for the washer. This methodology allows for the clamping band to be thin so that the addition of the clamping need not affect the size of the spin tub.

FIG. 7 is a perspective view of the flat metal clamping band 26 and upper spin tub body 22 prior to forming operations. The metal clamping band 26 and upper spin tub body 22 are both cylindrical in shape. The parts at this stage in the process are slightly smaller in diameter than they are in final form. The metal clamping band 26 is preferably positioned proximate the open top end 33, and on the outside of the upper spin tub body 22.

The method of manufacturing of the present invention includes providing a metal spin tub body and providing a metal band to reinforce the spin tub body. Preferably, both the metal band and the spin tub body are formed from stainless steel. The metal band and the metal spin tub body are welded to form two cylindrical parts. Preferably plasma welding is used to form a smooth and precise weld. The metal band and the metal spin tub body are expanded together to create internal stresses in the part to increase the rigidity of the assembly. Preferably the combined expanded metal clamping band and metal spin tub body can then be roll formed to provide additional strength and mechanically lock the band 26 to the spin tub body 22. A plurality of lanced tabs 44 formed in the spin tub assembly 32 further lock the clamping band 26 to the upper spin tub body 22.

It should be apparent that the expanded metal clamping band 26 of the present invention serves to reinforce the spin tub 22. The present invention contemplates variations in materials, the specific configuration of the washer, and is not to be limited to the preferred embodiment shown herein.

1. A washer comprising:
a cabinet;
an outer tub disposed within the cabinet;
a spin tub rotatably mounted within the outer tub;
the spin tub comprising a metal spin tub body and metal clamping band to reinforce the spin tub;
the spin tub formed through expanding the metal spin tub body and the metal clamping band together.

2. The washer of claim 1 wherein the metal clamping band is of a substantially cylindrical shape.

3. The washer of claim 1 wherein the metal clamping band is steel.

4. The washer of claim 1 wherein the metal clamping band and the metal spin tub body are both steel.

5. The washer of claim 1 wherein the metal clamping band is positioned along a top portion of the metal spin tub.

6. The washer of claim 1 wherein the spin tub body and metal clamping band are roll-formed after the expanding process.

7. The washer of claim 1 wherein the metal spin tub body is an upper body, the spin tub further comprising a lower body operatively connected to the upper body.

8. A spin tub for use in a washer comprising:
a substantially cylindrical spin tub body formed from a metal;
metal clamping band to reinforce the spin tub body;
the spin tub formed through expanding the metal spin tub body and the metal clamping band together.

9. The spin tub of claim 8 wherein the metal clamping band is substantially cylindrically shaped.

10. The spin tub of claim 8 wherein the metal clamping band is positioned along a top portion of the metal spin tub.

11. The spin tub of claim 8 wherein the metal clamping band is steel.

12. The spin tub of claim 8 wherein both the metal clamping band and the spin tub body comprise steel.

13. A method of manufacturing a spin tub comprising:
providing a metal spin tub body;
providing a metal band to reinforce the spin tub body;
placing the metal band outside the metal spin tub body;
expanding the metal band and the metal spin tub body together.

14. The method of claim 13 further comprising roll forming the metal band and metal spin tub body.

15. The method of claim 13 wherein the metal band and metal spin tub are formed of steel.

16. The method of claim 13 wherein both the metal spin tub body and the metal band are substantially cylindrical in shape.

17. The method of claim 13 wherein the metal clamping band is positioned along a top portion of the metal spin tub.

18. The method of claim 13 wherein the metal spin tub body is an upper body.

19. The method of claim 18 further comprising operatively connecting the upper body with a lower body.

20. A washer comprising:
a cabinet;
an outer tub disposed within the cabinet;
a spin tub rotatably mounted within the outer tub;
the spin tub comprising;
a) a metal spin tub body having a substantially cylindrical shape and a top end and an opposite bottom end, the top end being open for inserting and removing laundry;
b) a metal clamping band on an outer surface of the spin tub body to reinforce the spin tub and thereby prevent deformation of the spin tub body;
c) the metal clamping band positioned proximate the top end of the spin body;
d) the spin tub formed through expanding the metal spin tub body and the metal clamping band together.
